(19) United States
(12) Patent Application Publication
(10) Pub. No.: US 2006/0156334 A1
(43) Pub. Date: Jul. 13, 2006

(54) Playback system with remote control device

(75) Inventors: Lutz Schneidereit, Vienna (AT); Wolfgang Wimmer, Vienna (AT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/518,833

(22) PCT Filed: Jun. 20, 2003
(86) PCT No.: PCT/IB03/02824

§ 371 Date: Dec. 21, 2004

(30) Foreign Application Priority Data
Jun. 28, 2002 (EP) 02100766.1

(51) Int. Cl. H04N 5/445

(52) U.S. Cl. 725/37

(57) ABSTRACT

In a playback system (400) comprising a meta data generating device (430) meta data information (MD) is transmitted to a remote control device (420), which remote control device (420) is provided for the remote control of a playback device (10) with the aid of selection information (AI) from the meta data information (MD). The playback device (10) and the meta data generating device (430) have a receiving device (432, 40) for receiving a data carrier, in which a data carrier (41) can be inserted, which data carrier (41) contains at least one track, each track being determined by start position information. The meta data generating device (430) is provided for generating meta data information (MD) which additionally contains the start position information. In the remote control device (420) is included selection information generating means (425) for generating selection information (AI) which contains start position information. The playback device (10) includes a processing means (51, 60) for processing selection information (AI) which contains start position information, a selection of a track being enabled by means of the selection information (Ai).

The invention relates to a playback system comprising a meta data generating device for generating meta data information and comprising a remote control device for remote control of a playback device for playing back, and comprising the playback device, the meta data generating device comprising the means defined hereafter, namely receiving means for receiving a data carrier and meta data generating means for generating meta data information relating to the data carrier, and meta data transmission means for transmitting the meta data information to the remote control device, and in which the remote control device comprises the means defined hereafter, namely receiving means for receiving the meta data information, storage means for storing the meta data information, selection information generating means for generating selection information, and transmission means for transmitting the selection information to the playback device, and in which the playback device comprises the means defined hereafter, namely receiving means for receiving a data carrier and playback means for playing back user information contained on the data carrier, receiving means for receiving the selection information from the remote control device, and processing means for processing the selection information, user information contained on the data carrier being selectable by the processing means.

The invention further relates to a meta data generating device for generating meta data information, the meta data generating device comprising the means defined hereafter, that is, receiving means for receiving a data carrier, meta data generating means for generating meta data information relating to the data carrier and meta data transmission means for transmitting the meta data information to a remote control device for remote control of a playback system.

The invention further relates to a remote control device for remote control of a playback system, the remote control device containing the means defined hereafter, that is, receiving means for receiving meta data information, storage means for storing the meta data information, selection information generation means for generating selection information, and transmission means for transmitting the selection information to the playback system.

The invention further relates to a playback system comprising the means defined hereafter, namely receiving means for receiving a data carrier, playback means for playing back user information contained on the data carrier, receiving means for receiving selection information from a remote control system for remote control of the playback system, and processing means for processing the selection information, user information contained on the data carrier being selectable.

Such a playback system and such systems and devices are known for example from the document “A personal digital assistant as an advanced remote control for audio/video equipment”, which document was published in the 2002 on the Internet under “http://www.xs4all.nl/˜devet/atwork/i99w4.html”. The known playback system comprises a meta data generating device for generating meta data information relating to at least one data carrier, a playback system for playing back user information and a data carrier and a remote control device for remote control of the playback system. The remote control device is arranged as a so-called personal digital assistant (PDA) and is used for making a selection of user data of a data carrier possible. The playback system is arranged for playing back audio data while a computer program is used, which computer program is known as “Winamp MP3 player” and can be processed on a personal computer PC. The PC contains a number of user data in the form of audio files, which audio files are compressed according to the known MPEG 1 layer III (MP3) method. The audio files are formed as a CD collection of audio files of many different data carriers, which data carriers are arranged as compact discs CDs. Adding audio files of a CD to the CD collection is made by inserting the CD in receiving means of the PC, which receiving means are formed by a CD-ROM drive. The audio files are stored in storage means of the PC, which storage means are formed by a hard disk. If the audio files are then available in the CD-DA format, they are first compressed according to said MP3 method before they are stored.

If such audio files are added to such a CD in the CD collection, so-called meta data are generated from or for the audio files in the meta generation system contained in the PC. The meta data are generated by means of a database available on the Internet to which an Internet link available on the PC can have access. Such a database is known for example as CDDB® and is an Internet-based service or database respectively, in which meta data such as title, interpret, playing time etc. of many compact discs or audio CDs are stored. CDDB was developed to ease the detection of such CDs on a PC. The principle is then that a unique identification data block or disc ID, respectively, or ID respectively, is generated by a table of contents (TOC), thus a table of contents of a CD, and together with entered CD meta data or addition information referring to title, interpret etc. are stored in the CDDB database. Users using a CD are shown or rendered available to them the meta data or additional information stored in the CDDB database.

The meta data are formed here by artist/interpreter, name of album, year and genre. The meta data which are generated or obtained respectively are stored in a list or a catalogue respectively on the hard disk and subsequently transmitted to the PDA. The transmission is effected via an infrared link IrDA, where the PC and the PDA have an infrared transceiver. The list transmitted to the PDA is stored in the PDA and can be displayed on a display of the PDA. Further, an entry may be taken from the list, which entry represents selection information relating to a desired audio file of the CD collection to be played back in the playback system. Subsequent to the selection the selection information can be transmitted to the PC or display system by means of the IrDA connection. In the playback system there is finally a selection by means of the received selection information and subsequent playback of an audio file.

With the known playback system the selection information is formed by the name of the album and the names of the interpreters of a selected entry of the list. In most cases these names have a considerable number of characters. A transmission of many characters over the IrDA connection costs much time and thus uses up respective supply energy for the IrDA connection for a longer period of time, which is highly disadvantageous with a view to a minimum possible energy consumption in the PDA, because the energy consumption is covered by batteries and a shorter operating lifetime of the PDA is caused by higher energy consumption.

To have more clarity or for better distinction, often a so-called index or file structure is provided in the storage means of the playback device, individual audio files being stored in different indices. A selection of such audio files stored in indices requires so to speak a transmission of selection information which additionally has index information. Additional characters can then be transmitted over the IrDA connection, which is disadvantageous. More particularly a transmission of many characters is disadvantageous for the transmission security, which relatively strongly drops with the rising number of characters to be transmitted and therefore requires costly security measures. Moreover, long transmission times of selection information are disadvantageous if selections are desired immediately after one another.

It is an object of the invention to eliminate the restrictions and problems defined above and provide an improved playback system of the type defined in the opening paragraph and an improved meta data generating device of the type defined in the second paragraph and an improved remote control of the type defined in the third paragraph and an improved playback device of the type defined in the fourth paragraph, in which the problems defined above are avoided.

To achieve the object defined above, a playback system according to the invention has features according to the invention so that a playback system according to the invention can be characterized as follows, namely:

A playback system with a meta data generating device for generating meta data information and comprising a remote control for remote control of a playback device for playing back, and comprising the playback device, the meta data generating device comprising the following means, namely receiving means for receiving a data carrier and meta data generating means for generating meta data information relating to the data carrier and meta data transmission means for transmitting the meta data information to the remote control device and the remote control device comprising the receiving means for receiving the meta data information and storage means for storing the meta data information and selection information generating means for generating selection information and transmission means for transmitting the selection information to the playback device, and the playback device comprising the means defined hereinafter, namely receiving means for receiving a data carrier and playback means for playing back user information contained on the data carrier and receiving means for receiving the selection information from the remote control device and processing means for processing the selection information, user information contained on the data carrier being selectable by means of the processing means, characterized in that a data carrier that can be inserted in the receiving means comprises at least one track, each track being determined by start position information and the meta data generating means being arranged for generating meta data information which additionally includes the start position information, and the selection information generating means being arranged for generating selection information containing start position information, and the processing means being arranged for processing selection information containing start position information, with the aid of which selection information containing start position information of a track is made possible.

To achieve the object defined above a meta data generating device according to the invention has characteristic features according to the invention so that a meta data generating device according to the invention can be characterized in the following way, namely:

A meta data generating device for generating meta data information, which meta data generating device comprises the means defined below, namely receiving means for receiving a data carrier and meta data generating means for generating meta data information relating to the data carrier and meta data transmission means for transmitting the meta data information to a remote control device for remote control of a playback device, characterized in that a data carrier that can be inserted in the receiving means comprises at least one track and each track is determined by start position information, and the meta data generating means are arranged for generating meta data information which additionally contains the start position information.

To achieve the object defined above, a remote control device according to the invention has characteristic features according to the invention so that a remote control device according to the invention can be characterized in a manner defined below, namely:

A remote control device for remote control of a playback device, the remote control device comprising the means defined below, namely receiving means for receiving meta data information and storage means for storing the meta data information and selection information generating means for generating selection information and transmitting means for transmitting the selection information to the playback device, characterized in that the meta data information additionally contains start position information of tracks of a data carrier, the selection information generating means being arranged for generating selection information which contains start position information.

To achieve the object defined above, a playback device according to the invention has characteristic features according to the invention so that a playback device according to the invention can be characterized in the way defined below, namely:

A playback device which comprises the means defined below, namely receiving means for receiving a data carrier and playback means for playing back user information present on the data carrier and receiving means for receiving selection information from a remote control device for remote control of the playback device and processing means for processing the selection information, which user information present on the data carrier can be selected, characterized in that a data carrier that can be inserted in the receiving means comprises at least one track while each track is determined by start position information, and the processing means are arranged for processing selection information which contains start position information, while a selection of a track is made possible by selection information which contains start position information.

When the characteristic features according to the invention are provided, an improved playback system is obtained for playing back user data of a data carrier while the user data are formed by tracks of files. A considerable improvement is the fact that selection information contains start position information, which selection information can be switched from a remote control device to a playback device for the purpose of a selection and subsequent playback of the tracks or files. Since the start position information is formed by few characters, a switching or transmission of the characters from the remote control device to the playback device lasts only a brief moment which, with a view to a minimum possible energy consumption in the remote control device, is highly advantageous because the energy consumption in the remote control device is advantageously provided by batteries.

A further advantage is that by the use of the start position information there is no dependence on an index structure of the data carrier.

It has proved to be highly advantageous if features according to claims 4, 10, 15 and 18 are provided. They make it possible to select a great many mutually different data carriers.

By providing the features as claimed in claim 5 or claim 11 or claim 19 respectively, the advantage is achieved that enhanced security is made possible for the recognition of a great many mutually different data carriers.

Furthermore, by providing the features as claimed in claim 6 or claim 12 or claim 20 the advantage is obtained that data carriers with tracks containing files can be selected, while there is much certainty for the recognition of data carriers having only a small number of tracks, but yet many files.

By providing the characteristic features according to the claims 7, 13, 16 and 21 the advantage is obtained that simple and unique start position information can be formed.

By providing the characteristic features as claimed in claim 8, particularly the advantage is obtained that simple selection information can be transmitted by infrared transmission means used on a large scale according to the RC 6 standard.

By providing the characteristic features as claimed in claim 2 the advantage is obtained that receiving means for receiving a data carrier can be used in common with a meta data generating device and a playback device.

By providing the characteristic features as claimed in claim 3 the advantage is obtained that the transmission means for transmitting the meta data information can be produced in a simple way by an electrically conducting link which is particularly favorable for a small energy consumption of the remote control device.

The aspects defined above and further aspects of the invention are apparent from the examples of embodiment to be described hereinafter and are explained with reference to this example of embodiment.

These and other aspects of the invention are apparent from and will be elucidated with reference to the embodiments described hereinafter.

In the drawings:

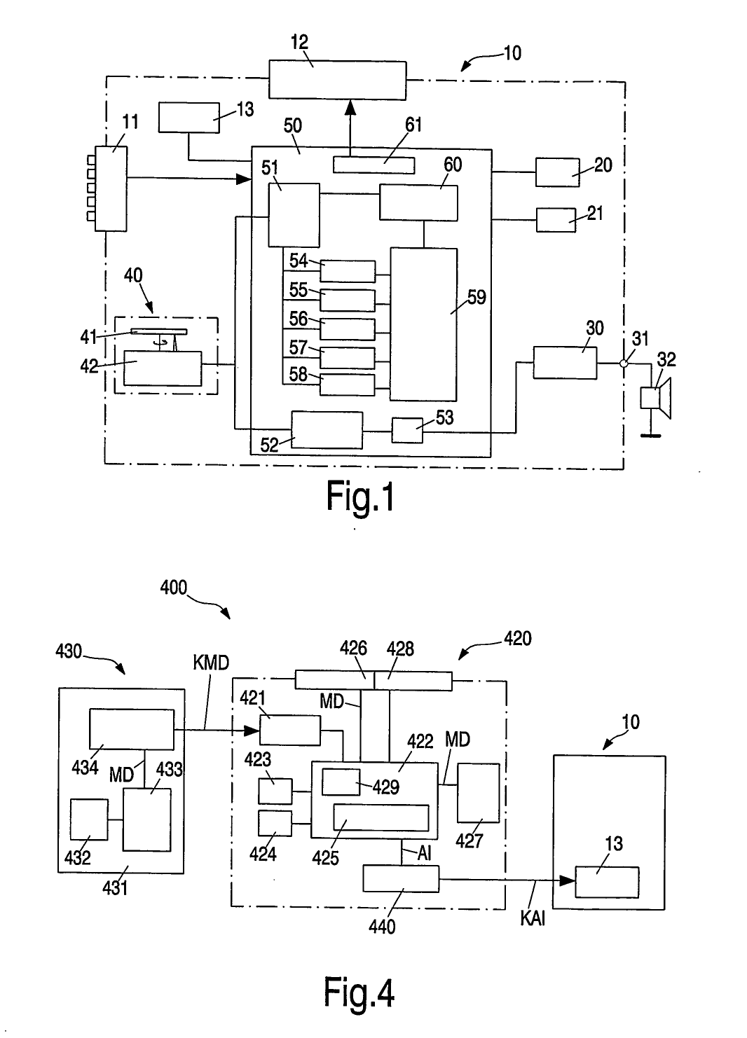

FIG. 1 shows in a highly diagrammatic form in a block diagram, a part that is essential to the present connection of an arrangement according to one embodiment of the invention,

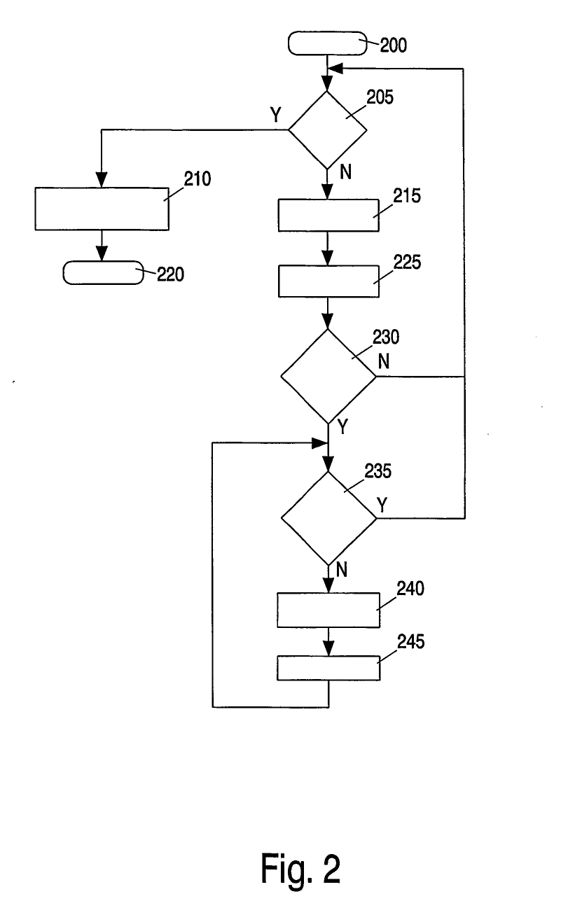

FIG. 2 shows a flow chart relating to the generation of a part identification block from items of start position information for tracks and/or files,

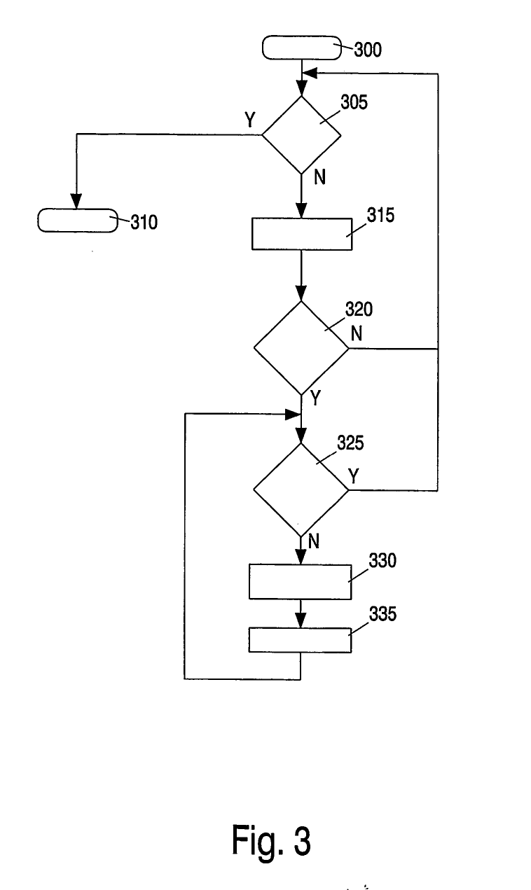

FIG. 3 is a flow chart relating to the generation of a part identification block from the file names

FIG. 4 is a block circuit diagram that shows, in highly diagrammatic form, a playback system for selecting user data on a data carrier by means of an identification data block and a track/file identification data block.

FIG. 1 shows an arrangement for the generation of an identification data block, which arrangement is in the form of a playback device 10 for playing back a number of data carriers. The playback device 10 contains receiving means for receiving a data carrier, which receiving means are formed by a changer module 40, which changer module 40 is intended and arranged to play back information or data that has been stored digitally, which digitally stored information is stored on data carriers 41 that can be read optically and that rotate at an angular velocity ω. In the present case the optically readable data carriers 41 are formed by compact discs (CDs) and can each be brought to a playback position in the changer module 40 by a changing mechanism. The digitally stored information is stored in tracks on the data carriers 41 in accordance with a CD-ROM standard. It may be mentioned that the CDs may be either CD-R or CD-RW types. The information or data that is digitally stored on the optically readable data carriers 41 can be read and pre-processed by a scanning arrangement 42, which scanning arrangement 42 comprises a positionable optical reading unit and an associated positioning control unit. The data that is read out and pre-processed is transmitted to a central control unit (CPU) 50.

The central control unit (CPU) 50 is in the form of a microprocessor and is coupled to a non-volatile memory ROM 20 and a volatile memory RAM 21, which ROM 20 and RAM 21 are intended and arranged for known purposes. The playback device 10 further contains input means 11, which input means 11 are formed by keys that are mounted on the surface of the playback device 10, that are connected to the central control unit (CPU) 50 and that are arranged for the input of control information by a user of the playback device 10. Also contained in the playback device 10 and connected to the central control unit (CPU) 50 is a remote control sensor 13 that is arranged to receive infrared remote-control signals according to the RC 6 standard. The playback device 10 further comprises display means 12 for displaying text and/or image information. The display means 12 are an LCD dot-matrix display in the present case, that is mounted on the surface of the playback device 10. It may be mentioned that such display means 12 may equally well be formed by a VFD display or other similar displays.

Also contained in the playback device 10 and connected to the central control unit (CPU) 50 is an amplifier module 30 for amplifying an analog audio signal, which amplified audio signal is transmitted to an amplifier output 3 1. Connected to the amplifier output is an audio playing back means 32 in the form of a loudspeaker, which loudspeaker is arranged to play back the amplified analog audio signal.

The central control unit (CPU) 50 contains a range of means and modules that are listed below and are able to gain access to the RAM 21. Contained in this way are: a CD-module control unit 51 that is connected to the changer module 40 and is arranged to control the changer module 40 and to determine items of start position information and file names. Connected to the CD-module control unit 51 are first generating means 54, second generating means 55, third generating means 56, fourth generating means 57 and fifth generating means 58, which said generating means 54 to 58 are arranged to generate part identification blocks that will be dealt with in detail later on. The said generating means 54 to 58 are connected to gating means 59 which are intended and arranged to generate an identification data block from the part identification blocks. Connected to the gating means 59 and the CD-module control unit 51 are comparator means 60 which are arranged to compare identification data blocks and items of selection information. The central control unit (CPU) 50 further contains display driver means 51 by which data representing textual and/or image information is produced for the display means 12. The central control unit (CPU) 50 further contains audio data decoding means 52 which are connected to the changer module 40 and are arranged to decode an audio signal. The decoded audio data is transmitted to a D/A converter 53, which D/A converter 53 generates an analog audio signal from the decoded audio data and transmits it to the amplifier module 30.

As has already been mentioned, the changer module 40 is intended and arranged to play back a number of CDs, the changer being a 5-disc changer in the present embodiment. The playback device 10 and the advantageous features make it possible for the CDs contained in the changer module 40 to be selected and play back, that is to say, on the basis of identification data blocks that are generated. The selection process will be looked at in more detail later on.

Described in detail below is the generation of the identification data block from the part identification blocks, in which case basic facts about stored data and items of start position information will first be explained by reference to an illustrative CD.

By means of the CD-module control unit 51, contents information, a so-called table of contents (TOC) is read out from the illustrative CD that is situated in the playback position in the changer module 40 and the data obtained is stored in the RAM 21. The illustrative CD that has been read from contains data arranged in a manner conforming to a CD-Rom standard, as shown in Table 1.

TABLE 1

| | | | size |
|---|---|---|---|
| CD | name | LBA | (bytes) |
| Session 1 | Session 1 | 0 | 4,685,824 |
| Track 01 | Track 01 | 0 | 5,381,376 |
| Session 2 | Session 2 | 13688 | 927,744 |
| Track 02 | Track 02 | 13688 | 927,744 |
| ISO 010305_1421 | GUNS ‘N˜7.MP3 | 13713 | 417,042 |
| 010305_1421 | GUNS ‘N’ ROSES-DON'T | 13712 | 417,042 |
| | CRY.MP3 | | |

The illustrative CD thus contains a session 1 having an audio track 01 and a session 2 having a data track 02. The data track 02 contains a file system to the ISO 9660 format and a file having the file name “GUNS 'N’ ROSES—DON'T CRY.MP3”, which file contains audio data that has been compressed under the known MPEG 1 layer III (MP3) standard. It may be mentioned that a data track may equally well contain a file system in a different format, such as the JOLIET format for example.

Shown in the column headed LBA are so-called logic block addresses, which logic block addresses define track and file start times, i.e. the items of information on the starting positions (offsets) of the tracks and files. The logic block addresses are specified in relation to the start time of a very first track on the CD. In the case of the present data track, 2048 bytes correspond, by definition, to a logic block for data tracks. In the case of the audio track, 2352 bytes correspond to a logic block for audio tracks, with 2048 of the bytes representing so-called raw data and the remaining bytes comprising correcting data and frame information data. Under the CD-ROM standard, the starting times of the tracks and the so-called lead-out LO can be determined from the TOC data or from time information stored on a subcode channel Q. This determination is carried out in the CD-module control unit 51, the time information being given in frames, where 75 frames equals one second. What are obtained for the illustrative CD cited above are track 01=150 frames, track 02=13838 frames and lead-out=14291 frames. What lead-out means here is the lead-out of the last session that was completed. A precise relationship between the start times from the TOC and the logic block addresses LBA is given in Table 2 below for the illustrative CD cited:

TABLE 2

| | |
|---|---|
| S1 audio | S2 digital |

| | | |
|---|---|---|
| Session | 4,685,824 | 927,744 |

Size [sector bytes]

| TOC | Lin1 | Gap 1 | Track 01 | Lout 1 | Lin 1 | Gap 2 | Track 02 | | Lout2 |
|---|---|---|---|---|---|---|---|---|---|
| Start [frames] | — | — | 150 | — | — | — | 13,838 | | 14,291 |
| Blocks | LI-S1 | Gap 1 | Track 01 | LO-S1 | LI-S2 | Gap 2 | Track 02 | | LO-S2 |
| Size [different] | 1 min | 150 | 5,381,376 | 1.5 min | 1 min | 150 frames | 927,744 sector bytes | | 1.5 min |
| | | frames | user bytes | | | | | | |
| Files | | | | | | | File system | File 2 | |
| | | | | | | | | 417,042 | |
| Size [different] | | | | | | | 25 frames | sector bytes | |
| Start [LBA] | — | — | 0 | 2,288 | 9,038 | 13,538 | 13,688 | 3,713 | 4,141 |

In Table 2, LI-S1 and LI-S2 mean the lead-in information for sessions S1 and S2 respectively and Gap1 and Gap2 mean the unoccupied gaps before the beginnings of the respective tracks, namely track 01 and track 02.

In the present case, five (5) part identification blocks are used to generate or form the identification data block, with an XOR gating of the part identification blocks being carried out in the gating means 59. In Table 3 below is shown a layout for the part identification blocks for the gating to form the identification data block ID.

TABLE 3

| | |
|---|---|
| | Part-ID3 (XOR of file name) |
| XOR | Part-ID1 (XOR of track & file start times) |

| | |
|---|---|
| XOR | Part-ID5 (total playing time of CD) |

| | |
|---|---|
| XOR | Part-ID4 (number of files) |

| | |
|---|---|
| XOR | Part-ID2 (number |
| | of tracks |
| ID | |

In this case, the identification data block ID comprises four (4) bytes corresponding to the blocks shown in Table 3, the blocks being numbered from right to left.

FIG. 2 shows a sequence in which a part identification block ID1 is generated from the track or file start-position information, i.e. the start times for tracks or LBAs for files, by the first generating means 54 and the CD-module control unit 51. The sequence is referred to below as the part-ID1 sequence. The part-ID1 sequence is carried out iteratively for a number of tracks on a relevant CD and begins at a start box 200, where a part-ID1 variable is set to 0×0 in the RAM 21. Then, according to a box 205, an enquiry is made as to whether a last track on the CD has already been read. If it has, a branch is made to a box 210; if not the sequence continues to box 215. According to box 215, the next track is read and the sequence then continues to box 225. What reading of the next track means in this case is the determination of the start position information. According to box 225, XOR gating of the item of start information that has been determined or read takes place with part-ID1. An enquiry is then made according to box 230 as to whether the track read is an audio track, or a data track containing files. If it is an audio track, the part-ID1 sequence continues to box 205. If, on the other hand, it is a data track, the sequence continues to a box 235. According to box 235, it is checked whether a final file in the data track has already been read. If it has, the part-ID I sequence once again continues to block 205. If a final file has not been read, the sequence continues to box 240, where the next file is read. In this case too, reading of the next file means determination of the start position information. Following box 240, there then takes place, according to a box 245, XOR gating of the items of start position information that have been determined or read with the part-ID1 stored in RAM 21, after which the part-ID1 sequence continues to box 235. What is obtained for part-ID1 in the case of the illustrative CD cited above is

Part-ID1=TOC(Track01) XOR TOC(track 02) XOR LBA (File2)==150 XOR 13,838 XOR 13,713=0×309

Finally, part-ID1 having been generated or determined, there takes place according to box 210 by multiplication by a value 0×100 a shift of part-ID1 to a second byte position in the identification data block, as can be seen in Table 3, whereupon the part-ID1 sequence comes to an end in a box 220.

FIG. 3 shows a sequence in which a part identification block ID3 is generated from the file names by the third generating means 56 and the CD-module control unit 51. The sequence is referred to below as the part-ID3 sequence. The part-ID3 sequence once again defines an iterative read-in of tracks and files by means of the CD-module control unit 51 and begins at a start box 300, where a part-ID3 variable comprising four (4) bytes is set to 0×0 in the RAM 21. Then, according to a box 305, an enquiry is made as to whether a last track on the CD has already been read. If it has, a branch is made to a box 310; if not the sequence continues to box 315. According to box 315 the next track is read, whereupon an enquiry is made according to a box 320 as to whether the track read is an audio track, or a data track containing files. If it is an audio track, the part-ID3 sequence continues to box 305. If on the other hand it is a data track, the sequence continues to a box 325. According to box 325 it is checked whether a final file in the data track has already been read. If it has, the part-ID3 sequence is once again continued to block 305. If a final file has not been read, the sequence continues to box 330. According to box 330 the file name of the next file is read and the sequence then continues to a box 335. According to box 335, the formation of part-ID3 finally takes place by the XOR gating of characters of the file name, thus producing a part-ID3 that has the same number of bytes. In the present case, a division of the characters in the file name into blocks is carried out, the division being made into blocks each containing four (4) characters, in which case four (4) character positions are obtained in a block with the character positions each representing one byte. The XOR gating takes place in each block with the characters in each character position in the blocks, meaning for example that the characters one (1), five (5), nine (9) etc. are gated and form the first byte of part-ID1. The characters two (2), six (6), ten (10) etc. form the second byte of part-ID1. In the division into blocks, missing characters, or character positions that are unoccupied in a final block due to the division, are set to zero (0). What is obtained for part-ID3 in the case of the illustrative CD cited above is:

Part-ID3=4 byte XOR of “GUNS 'N' ROSES—DON'T CRY.MP3”=0×1244530951

Part identification block part-ID2 is obtained by means of the second generating means 55 and the CD-module control unit 51, part-ID2 representing the total number of tracks on a CD.

Part identification block part-ID4 is obtained by means of the fourth generating means 57 and the CD-module control unit 51, part-ID4 representing the total number of files on a CD. The total number of tracks can easily be determined from the TOC that is read. The total number of files can be determined from the file system that is stored within the first 25 frames of a data track. In the case of the illustrative CD cited above, what is obtained for part-ID2 is 0×1 and what is obtained for part-ID4 is 0×2. As shown in Table 3, part-ID2 is set to the fourth byte position in the identification data block and part-ID4 is expanded to two (2) bytes.

As what is now the final part identification block, a part-ID5 is determined by means of the fifth generating means 58 and the CD-module control unit 51, the purpose of part-ID2 being an advantageous greater diversification of the identification data block. Part-ID5 represents the total length of a CD in this case. The total length is determined from the LBA and the size of the last completed session on a CD. What is obtained for part-ID5 in the case of the illustrative CD cited above is:

Part-ID5=LBA(Track02)+Size(Track 02)/2048 (bytes/logic block)=13,688+927,744/2048=0×373d

Gating of part identification blocks part-ID1 to part-ID5 by means of the gating means 59 produces, in the case of the illustrative CD cited above, an identification data block or a disk ID=0×1210922811.

As has already been mentioned, the playback device 10 is arranged to play back a number of data carriers 41, i.e. of CDs in the present case, by means of the changer module 40, thus producing a so-called jukebox or music-box. As has also already been mentioned, the CDs are so-called MP3 CDs that each contain a number of MP3 files, i.e. compressed audio files. In the present case where there are five (5) MP3 CDs, there may be a total number of up to a thousand (1000) MP3 files, which MP3 files should be easily selectable for the purposes of playback.

Shown in FIG. 4 is a playback system 400 for such easy selection of MP3 files for the purpose of playing back the said MP3 files. The playback system 400 contains a metadata generating arrangement 430, a remote-control arrangement 420 and a playback device 10. The playback device 10 is of the same design as the playback device 10 shown in FIG. 1.

The metadata generating arrangement 430 is in the form of a computer 431, which computer 431 is arranged to run a computer software product for the generation of metadata information relating to at least one data carrier. The computer 431 contains receiving means 432 for receiving a data carrier, which receiving means 432 connect to metadata generating means 433. The metadata generating means 433 are arranged to generate and emit metadata MD to transmission means 434, the transmission means 434 being arranged to emit coded metadata KMD. The receiving means 432 are formed in the present case by a CD-ROM drive belonging to the computer 431, and substantially correspond to the changer module 40 of the playback device 10, although it is only ever a single data carrier that can be received. The metadata generating means 433 contain modules and means that have already been described above in connection with FIG. 1 and by means of which an identification data block ID can be generated for a data carrier. These module and means are: the CD-module control unit 51, the generating means 54, 55, 56, 57 and 58 and the gating means 59.

From a data carrier of a type that was described above in connection with FIG. 1, which data carrier is inserted in the receiving means 432, metadata is generated with the help of the TOC read from the data carrier. The metadata comprises the follow data for each track or file recorded on the data carrier: title, name of interpreter, name of album, genre, and a track/file identification data block (FID) and an identification data block (disk ID) for the data carrier. The track/file identification data block FID is formed by reference to the start position (offset) information for the tracks or data files. For a track, this is the time information that can be obtained from the TOC. For data files, it is the sum of the time information for the track that contains a data file, and of an item of time information that is determined from the logic block address LBA of the data file relative to the logic block address LBA of the track. An item of time information is calculated or specified in the units of time hours, minutes, seconds and frames, with one (1) byte being used for each unit of time and with the hours occupying the byte in the most significant position and the frames the byte in the least significant position. What is obtained for the track/file identification data blocks in the case of the illustrative CD cited above is:

FID(track01)=TOC(Track01)=150 frames=00:00:02:00[hh:mm:ss:ff]=0×200

FID(File 02)=TOC(Track02)+(LBA(File02)−LBA(Track02)==13838+(13713−13688)=13863 frames=00:03:04:63[hh:mm:ss:ff]=0×30463

It may be mentioned that there are storage means present in the metadata generating arrangement 430, which storage means are connected to the metadata generating means 433 and are arranged to store the metadata MD. The storage means may be formed by a hard disk of the computer 431.

The remote-control arrangement 420 is in the form of a so-called personal digital assistant (PDA) in this case. The remote-control arrangement 420 has a central control unit 422 that is in the form of a microprocessor and that is coupled to a non-volatile memory ROM 424 and a volatile memory RAM 423, which ROM 424 and RAM 423 are intended and arranged for known purposes.

Connected to the central control unit 422 are reception means 421 that are arranged to receive and decode coded metadata KMD, storage means 427 that are arranged to store metadata MD, display means 426 that are arranged to display the metadata MD, and input means 428 for the input of input information. In the present case, the display means 426 and the input means 428 are formed by combined means that take the form of an LCD touch screen. The LCD touch screen operates on the resistance principle in this case, it being possible for input information to be generated on a surface of the LCD touch screen by means of a stylus or the like. It may be mentioned that other input means may equally well be provided, such as a keyboard or speech input means for example.

Contained in the central control unit 422 are metadata processing means 429 by which the metadata MD received by the receiving means 421 can be processed and can be stored in the storage means 427. Also contained in the central control unit 422 are selection information generating means 425, which selection information generating means 425 allow the metadata MD to be displayed on the display means 426 and which selection information generating means 425 are arranged to enable an item of selection information AI to be generated with the help of the input means 428. The item of selection information AI can be emitted to transmitting means 440, which transmitting means 440 are connected to the central control unit 422. The transmitting means 440 are arranged to emit coded selection information KAI, the coded selection information KIA being formed in this case by an infrared signal to the RC6 standard, the RC6 mode 1A—string type 3 being used. The coded selection information KAI can be transmitted to reception means of the playback device 10, which reception means are arranged to receive selection information and which are formed by the remote-control sensor 13.

The metadata MD is stored in the storage means 427 of the remote control device as a metadata list comprising list entries, which list entries represent the particular tracks or files on a data carrier by means of the respective sets of metadata MD. It may be mentioned that means are provided by which the metadata list can be managed, i.e. by which list entries can be added or deleted.

With the help of the selection information generating means 425, metadata MD can be displayed, the metadata list being displayable in a variety of views, meaning that the list entries are sortable and displayable by certain criteria, such for example as by the name of the interpreter, by title, by genre or by other sort criteria. If a list entry is selected by means of the input means, an associated identification data block (disk ID) and a track/file identification data block (FID) are found for the list entry and transmitted to the playback device 10 by the transmitting means 440 as selection information.

In the playback device 10, the selection information received is processed in that a check is made by means of the comparator means 60 on whether identification data blocks found for data carriers in the changer module 40 match the identification data block from the selection information AI received. If there is a match, the track/file identification data block FID received with the identification data block is passed on to the CD-module control unit 51, and in the CD-module control unit 51 a track or a file is caused to be played on that data carrier in which there is a matching identification data block. In the playback mode, coded audio data is transmitted to the audio data decoding means 52 in the present case.

If there is not a matching identification data block ID, the fact is notified by means of a display on the display means 12. It may be mentioned that notification may also be transmitted to the remote-control arrangement 420, in which case the playback device 10 will then have transmitting means for transmitting a message of this kind. It may also be mentioned that the playback device 10 can use the transmitting means mentioned to transmit generated identification data blocks IDs for data carriers contained in the changer module 40 to the remote control device 10. The remote-control arrangement 10 is arranged to receive and process identification data blocks ID of this kind in this event, in which case a display of the metadata list may comprise only those list entries that have matching identification data blocks.

It may also be mentioned that the playback system 400 may be arranged to generate and process so-called play lists.

1. A playback system (400) comprising a meta data generating device (430) for generating meta data information (MD) and comprising a remote control device (420) for remote control of a playback device (10) for playing back, and comprising the playback device (10), the meta data generating device (430) comprising the means defined hereafter, namely receiving means (432) for receiving a data carrier (41) and meta data generating means (433) for generating meta data information (MD) relating to the data carrier (41), and meta data transmission means (434) for transmitting the meta data information (MD) to the remote control device (420), and in which the remote control devices (420) comprises the means defined hereafter, namely receiving means (421) for receiving the meta data information (MD), storage means (427) for storing the meta data information (MD), selection information generating means (425) for generating selection information (AI), and transmission means (440) for transmitting the selection information (AI) to the playback device (10), and in which the playback device (10) comprises the means defined hereafter, namely receiving means (40) for receiving a data carrier (41) and playback means (51, 52, 53) for playing back user information contained on the data carrier (41), receiving means (13) for receiving the selection information (AI) from the remote control device (420), and processing means (51, 60) for processing the selection information (AI), user information contained and the data carrier (41) being selectable by the processing means (51, 60), characterized in that a data carrier (41) that can be inserted in the receiving means (432, 40) comprises at least one track, each track being determined by start position information and the meta data generating means (433) being arranged for generating meta data information (MD) which additionally include the start position information, and the selection information generating means (425) being arranged for generating selection information (AI) containing start position information and the processing means (51, 60) being arranged for processing selection information (AI) containing start position information, with the aid of which selection information (AI) containing start position information the selection of a track is made possible.

2. A playback system (400) as claimed in claim 1, characterized in that the meta data generating device (430) and the playback device (10) are contained in a combination device.

3. A playback system (400) as claimed in claim 1, characterized in that the meta data generating device (430) and the remote control device (420) are contained in a combination device.

4. A playback system (400) as claimed in claim 1, characterized in that the selection information (AI) contains an identification data block in addition to the start position information, which identification data block can be formed for a data carrier (41) that can be inserted in the receiving means (432).

5. A playback system (400) as claimed in claim 4, characterized in that for generating the identification data block in the meta data generating device (430) and/or in the playback device (10) comprises the following means, namely
determining means (51) for determining the start position information and gating means (59) for generating the identification data block by gating part identification blocks and
first generating means (54) for generating a first part identification block from the start position information-and
second generating means (55) for generating a second part identification block from a total number of tracks of the data carrier (41)
where the first generating means (54) are arranged for generating the first part identification block with the aid of an XOR gating and where the gating means (59) are arranged for generating the identification data block with the aid of an XOR function.

6. A playback system (400) as claimed in claim 5, characterized in that third generating means (56) are additionally provided which are arranged for generating a third part identification block from file names of files contained in the tracks of the data carrier (41).

7. A playback system (400) as claimed in claim 1, characterized in that the selection information (AI) is formed by an item of start position information, which start position information is determined by time information in hours, minutes, seconds and frames.

8. A playback system (400) as claimed in claim 7, characterized in that the selection information (AI) is arranged as a track identification data block having four bytes, the respective bytes having the respective time information in hours, minutes, seconds and frames.

9. A meta data generating device (430) for generating meta data information (MD), which meta data generating device (430) comprises the means defined below, namely receiving means (432) for receiving a data carrier (41) and meta data generating means (433) for generating meta data information (MD) relating to the data carrier (41) and meta data transmission means (434) for transmitting the meta data information (MD) to a remote control device (420) for remote control of a playback device (10), characterized in that a data carrier (41) that can be inserted in the receiving means (432) comprises at least one track and each track is determined by start position information, and the meta data generating means (433) are arranged for generating meta data information (MD) which additionally contains the start position information.

10. A meta data generating device (430) as claimed in claim 9, characterized in that the meta data information (MD) contains an identification data block in addition to the start position information, which identification data block can be formed for a data carrier (41) that can be inserted in the receiving means (432).

11. A meta data generating device (430) as claimed in claim 10, characterized in that for generating the identification data block the means defined below are comprised, namely
determining means (51) for determining the start position information and gating means (59) for generating the identification data block by gating part identification blocks and
first generating means (54) for generating a first part identification block from the start position information and
second generating means (55) for generating a second part identification block from a total number of tracks of the data carrier (41),
the first generating means (54) being arranged for generating the first part identification block with the aid of an XOR gating and
the gating means (59) being arranged for generating the identification data block with the aid of an XOR function.

12. A meta data generating device (430) as claimed in claim 11, characterized in that, in addition, third generating means (56) are provided which are arranged for generating a third part identification block from file names of files that are contained in the tracks of the data carrier (41).

13. A meta data generating device (430) as claimed in claim 9, characterized in that the start position information is determined by time information in hours, minutes, seconds and frames.

14. A remote control device (420) for remote control of a playback device (10), the remote control device (420) comprising the means defined below, namely
receiving means (421) for receiving meta data information (MD) and storage means (427) for storing the meta data information (MD) and selection information generating means (425) for generating selection information (AI) and transmitting means (440) for transmitting the selection information (AI) to the playback device (10), characterized in that the meta data information (MD) additionally contains start position information of tracks of a data carrier (41), the selection information generating means (425) being arranged for generating selection information (AI) which contains start position information.

15. A remote control device (420) as claimed in claim 14, characterized in that the meta data information (MD) and the selection information (AI) contains an identification data block in addition to the start position information, which identification data block can be formed for a data carrier (41).

16. A remote control device (420) as claimed in claim 14, characterized in that the selection information (AI) is formed by start position information which is determined by time information in hours, minutes, seconds and frames.

17. A playback device (10) which comprises the means defined below, namely
receiving means (40) for receiving a data carrier (41) and playback means (51, 52, 53) for playing back user information present on the data carrier (41) and receiving means (13) for receiving selection information (AI) from a remote control device (420) for remote control of the playback device (10) and processing means (51, 60) for processing the selection information (AT), which user information present on the data carrier (41) can be selected, characterized in that a data carrier (41) that can be inserted in the receiving means (40) comprises at least one track while each track is determined by start position information, and the processing means (51, 60) are arranged for processing selection information (AI) which contains start position information, while a selection of a track is made possible by selection information (AI) which contains start position information.

18. A playback device (10) as claimed in claim 17, characterized in that the selection information (AI) contains an identification data block in addition to the start position information, which identification data block can be formed for a data carrier (41) that can be inserted in the receiving means (40).

19. A playback device (10) as claimed in claim 18, characterized in that for generating the identification data block the means defined below are included, namely
determining means (51) for determining the start position information and gating means (59) for generating the identification data block by gating part identification blocks and
first generating means (54) for generating a first part identification block from the start position information and
second generating means (55) for generating a second part identification block from a total number of tracks of the data carrier (41),
the first generating means (54) being arranged for generating the first part identification block with the aid of an XOR gating and the gating means (59) being arranged for generating the identification data block with the aid of an XOR function.

20. A playback device (10) as claimed in claim 19, characterized in that third generating means (56) are additionally provided which are arranged for generating a third part identification block from file names of files included in the tracks of the data carrier (41).

21. A playback device (10) as claimed in claim 17, characterized in that the selection information (AI) is formed by start position information, the start position information being determined by time information in hours, minutes, seconds and frames.
